(19) United States
(12) Patent Application Publication
(10) Pub. No.: US 2006/0274409 A1
(43) Pub. Date: Dec. 7, 2006

(54) Optical sight for preventing mechanical interference in magnification unit

(75) Inventor: Shang-Yung Liang, Taichung (TW)

Correspondence Address: DARBY & DARBY P.C., P. O. BOX 5257, NEW YORK, NY, 10150-5257, US

(73) Assignee: ASIA OPTICAL CO., INC., Taichung (TW)

(21) Appl. No.: 11/377,771

(22) Filed: Mar. 15, 2006

(30) Foreign Application Priority Data
Jun. 3, 2005 (TW) 094118340

(51) Int. Cl. G02B 23/00

(52) U.S. Cl. 359/422; 359/399

(57) ABSTRACT

An optical sight includes: an outer barrel formed with a slot; an objective lens unit and an ocular lens unit mounted to opposite ends of the outer barrel; a magnification unit including a first inner barrel tiltably disposed in the outer barrel, a second inner barrel sleeved on the first inner barrel, lens assemblies movably disposed in the first inner barrel, an adjusting ring sleeved on the outer barrel, and an adjusting pin mounted to the adjusting ring; and an adjustment unit operable to adjust inclination of the first and second inner barrels. The second inner barrel is formed with a driven hole registered with the slot. The adjusting pin extends through and is movable along the slot, and includes a drive end received in the driven hole. The drive end is spherical, and has a diameter that is not larger than a diameter of the driven hole.

### CROSS-REFERENCE TO RELATED APPLICATION

This application claims priority of Taiwanese Application No. 094118340, filed on Jun. 3, 2005.

### BACKGROUND OF THE INVENTION

1. Field of the Invention

The present invention relates to an optical sight, more particularly to an optical sight that prevents interference between elements of a magnification unit.

2. Description of the Related Art

FIGS. 1 and 2 show a conventional optical sight for use with a firearm (not shown). The optical sight includes an outer barrel 1 formed with a cylindrically extending slot 101. The outer barrel 1 has first and second ends, and a longitudinal axis (X) as indicated in FIG. 2. An objective lens unit 2 is mounted to the first end of the outer barrel 1, and an ocular lens unit 3 is mounted to the second end of the outer barrel 1. The optical sight further includes a magnification unit 4, a pair of adjustment units 5, a pair of sealing rings 6, and a restoring spring 7.

The magnification unit 4 includes a first inner barrel 401 tiltably disposed in and extending between the first and second ends of the outer barrel 1, a second inner barrel 402 sleeved on the first inner barrel 401, a plurality of lens assemblies 403 movably disposed in the first inner barrel 401, an adjusting ring 404 sleeved on the outer barrel 1, and an adjusting pin 405 mounted to the adjusting ring 404. The first inner barrel 401 is formed with a plurality of first cam slots 4011 registered respectively with the lens assemblies 403, and is provided with a reticle 4012 in a known manner. The second inner barrel 402 is formed with a cylindrical driven hole 4021 registered with the slot 101, and a plurality of second cam slots 4022 registered respectively with the lens assemblies 403. Each of the lens assemblies 403 includes a guide pin 4031 that passes through a corresponding one of the first cam slots 4011 and that extends into a corresponding one of the second cam slots 4022. The adjusting pin 405 extends through and is movable along the slot 101, and includes a cylindrical drive end 4051 received in the driven hole 4021 in the second inner barrel 402.

The adjustment units 5 are mounted on the outer barrel 1. The adjustment units 5 may be manipulated by a user to effect windage and elevation adjustments of the reticle 4012. Each of the adjustment units 5 includes an adjusting element 501 with a lower end abutting against a front end of the first inner barrel 401, and a cover 502 surrounding the adjusting element 501. Upon removal of the cover 502, the adjusting element 501 may be manipulated to thereby adjust the position of the first and second inner barrels 410,402 relative to the longitudinal axis (X) of the outer barrel 1.

The sealing rings 6 are interposed between the outer barrel 1 and the adjusting ring 404, with the adjusting pin 405 disposed between the sealing rings 6.

The restoring spring 7 is interposed between the outer barrel 1 and the first inner barrel 401, and is disposed on a side of the first inner barrel 401 such that an urging force is provided to the first inner barrel 401 to abut against the adjustment units 5.

Operation of the adjustment unit 5 used for elevation control will now be described with reference to FIGS. 2 and 3. Manipulation of this adjustment unit 5 by the user results in upward or downward displacement of the adjusting element 501, which, in turn, effects upward or downward tilting of the front end of the first and second inner barrels 401,402. Hence, the reticle 4012 undergoes elevation adjustment, thereby allowing for correction between an aiming position of the optical sight and an actual bullet impact point. Similarly, by adjusting the other one of the adjustment units 5 (see FIG. 1), rightward and leftward correction of the reticle 4012 may be performed.

If the user desires to vary the magnification of the optical sight, the adjusting ring 404 is rotated such that the adjusting pin 405 moves within the angular range of the slot 101. Through engagement between the drive end 4051 of the adjusting pin 405 and the driven hole 4021 in the second inner barrel 402, the adjusting pin 405 moves the second inner barrel 402 to rotate relative to the first inner barrel 401. Furthermore, through interaction between the guide pins 4031 and the first and second cam slots 4011, 4022, the lens assemblies 403 are moved closer or farther apart from each other approximately along the direction of the longitudinal axis (X) of the outer barrel 1, thereby varying the magnification of the optical sight.

Although the conventional optical sight can achieve adjustment of the reticle 4012 in all directions, as well as magnification adjustment as intended, the optical sight is not without drawbacks.

As an example, user manipulation of one of the adjustment units 5 may result in downward inclination of the first and second inner barrels 401,402 relative to the longitudinal axis (X), as shown in FIG. 3. When such adjustment is to an extreme degree, since the driven hole 4021 in the second inner barrel 402 and the drive end 4051 of the adjusting pin 405 are both cylindrically shaped, the driven hole 4021 and the drive end 4051 may mechanically interfere with each other. If this occurs, precise inclination adjustment of the first and second inner barrels 401,402, and therefore, accurate adjustment of the reticle 4012 are no longer possible.

As another example, as a result of such mechanical interference between the driven hole 4021 and the drive end 4051, the driven hole 4021 may act on the adjusting pin 405 such that the adjusting pin 405 tilts the adjusting ring 404 forward, as shown in FIG. 4. This causes further mechanical interference to occur between the adjusting pin 405 and the slot 101, such that smooth rotation of the adjusting ring 404 during magnification adjustment is not possible. In addition, such tilting of the adjusting ring 404 may result in the same pressing down on one of the sealing rings 6 while releasing pressure on the other of the sealing rings 6. This may compromise the waterproof and airtight capabilities of the optical sight.

### SUMMARY OF THE INVENTION

Therefore, the object of the present invention is to provide an optical sight that prevents interference between elements of a magnification unit of the optical sight.

The optical sight of this invention comprises: an outer barrel having a longitudinal axis, formed with a circumferentially extending slot, and having first and second ends; an objective lens unit mounted to the first end of the outer barrel; an ocular lens unit mounted to the second end of the outer barrel; a magnification unit including a first inner barrel tiltably disposed in and extending between the first and second ends of the outer barrel, a second inner barrel sleeved on the first inner barrel, a plurality of lens assemblies movably disposed in the first inner barrel, an adjusting ring sleeved on the outer barrel, and an adjusting pin mounted to the adjusting ring, the second inner barrel being formed with a driven hole having a first diameter and registered with the circumferentially extending slot, the adjusting pin extending through and being movable along the slot from the adjusting ring and including a drive end received in the driven hole, the drive end being substantially spherical, and having a second diameter that is not larger than the first diameter of the driven hole; and an adjustment unit mounted on the outer barrel, and operable to adjust inclination of the first and second inner barrels in the outer barrel relative to the longitudinal axis of the outer barrel.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view of a conventional optical sight;

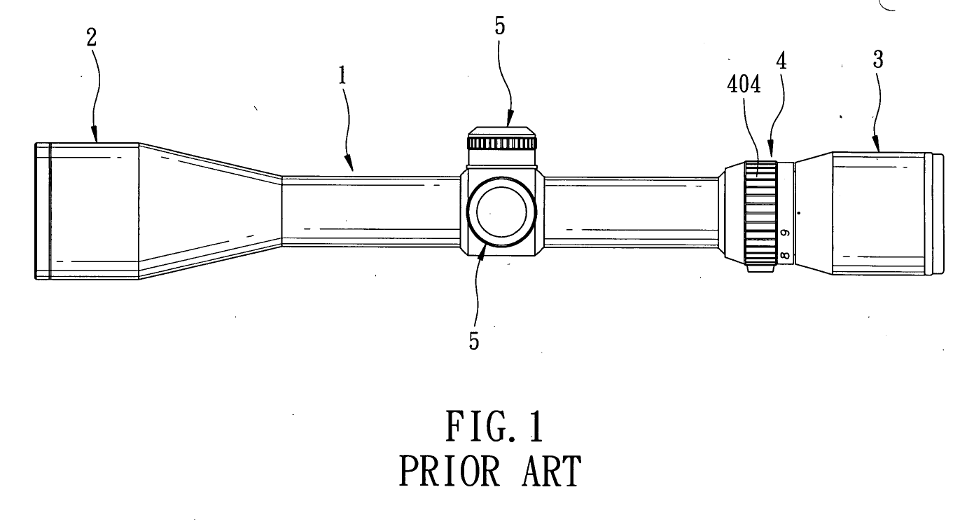

FIG. 2 is a fragmentary sectional view of the optical sight of FIG. 1;

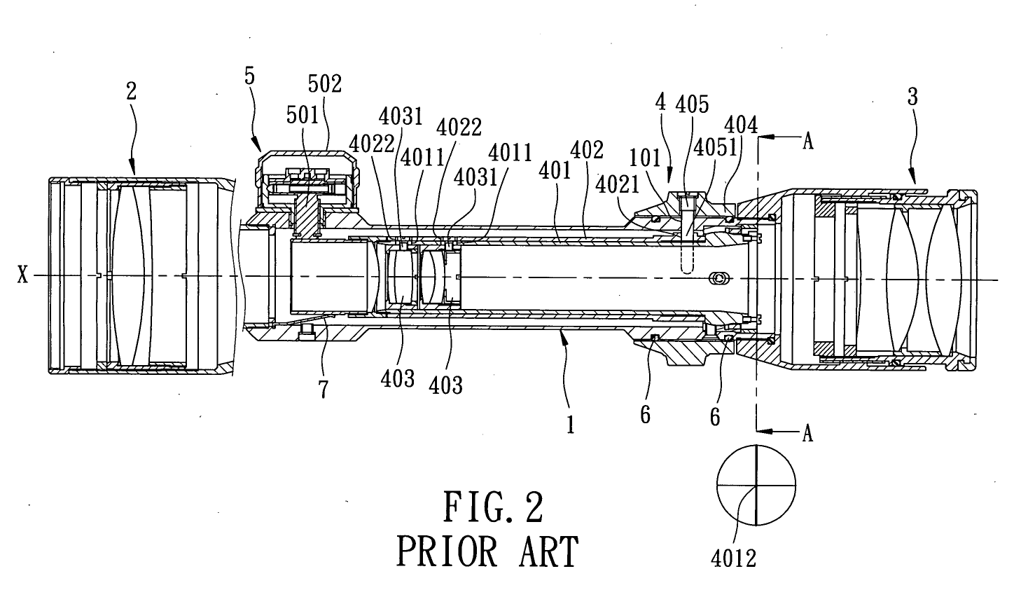

FIG. 3 is another fragmentary sectional view of the optical sight of FIG. 1, illustrating the optical sight following an elevation adjustment;

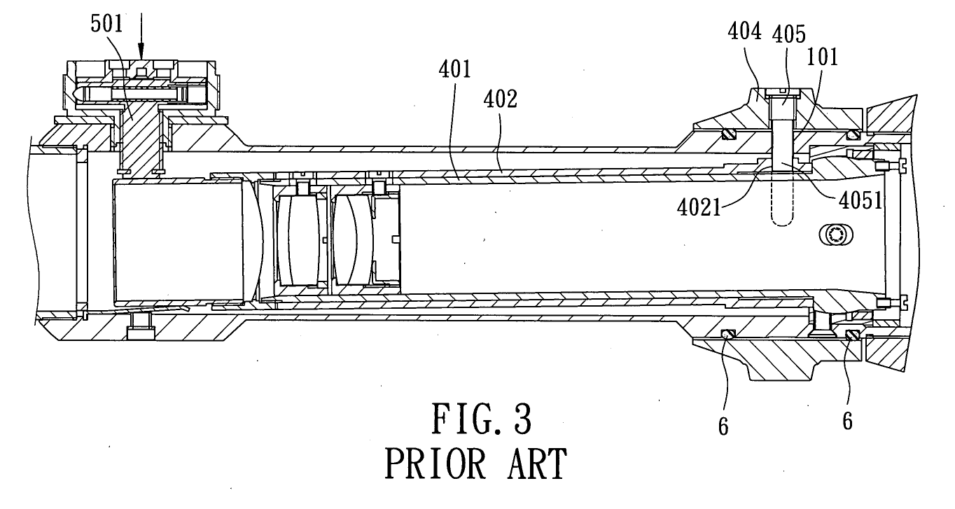

FIG. 4 is an enlarged fragmentary sectional view of the optical sight of FIG. 3;

FIG. 5 is a schematic view of an optical sight according to a preferred embodiment of the present invention;

FIG. 6 is a fragmentary sectional view of the preferred embodiment;

FIG. 7 is a sectional view of an outer barrel of the preferred embodiment;

FIG. 8 is a fragmentary sectional view of the preferred embodiment, illustrating the optical sight following an elevation adjustment; and

FIG. 9 is an enlarged fragmentary sectional view of the optical sight of FIG. 8.

### DETAILED DESCRIPTION OF THE PREFERRED EMBODIMENT

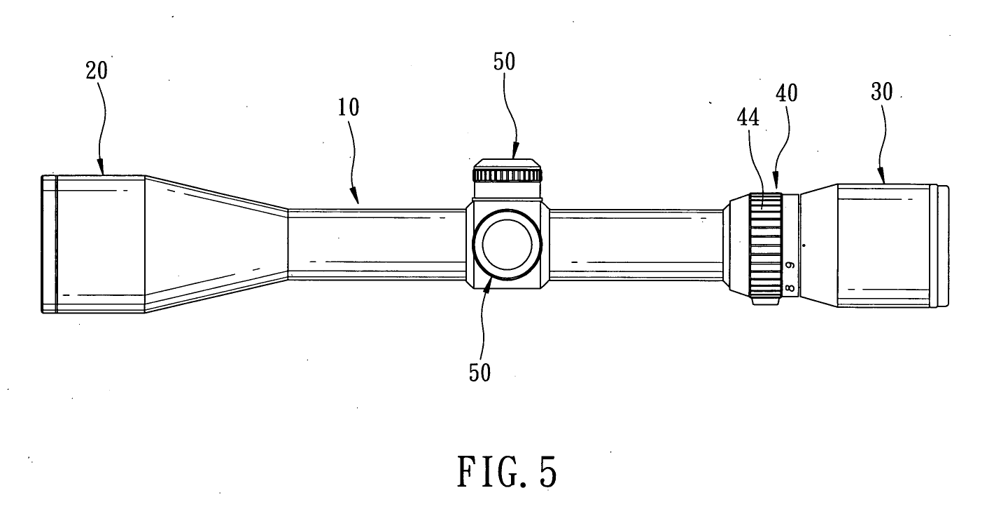

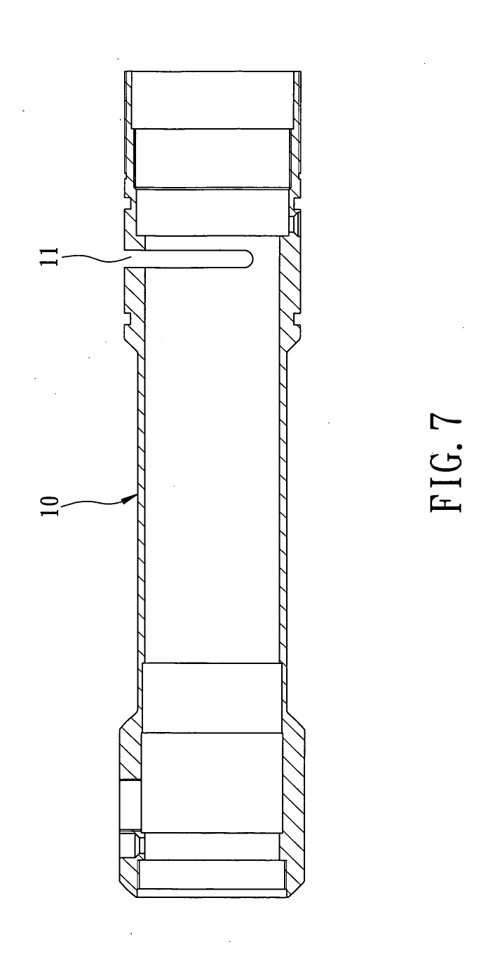

FIGS. 5, 6, and 7 show an optical sight according to a preferred embodiment of the present invention. The optical sight includes an outer barrel 10, an objective lens unit 20, an ocular lens unit 30, a magnification unit 40, a pair of adjustment units 50 (i.e., windage and elevation adjustment units), a pair of sealing rings 60, and a restoring spring 70.

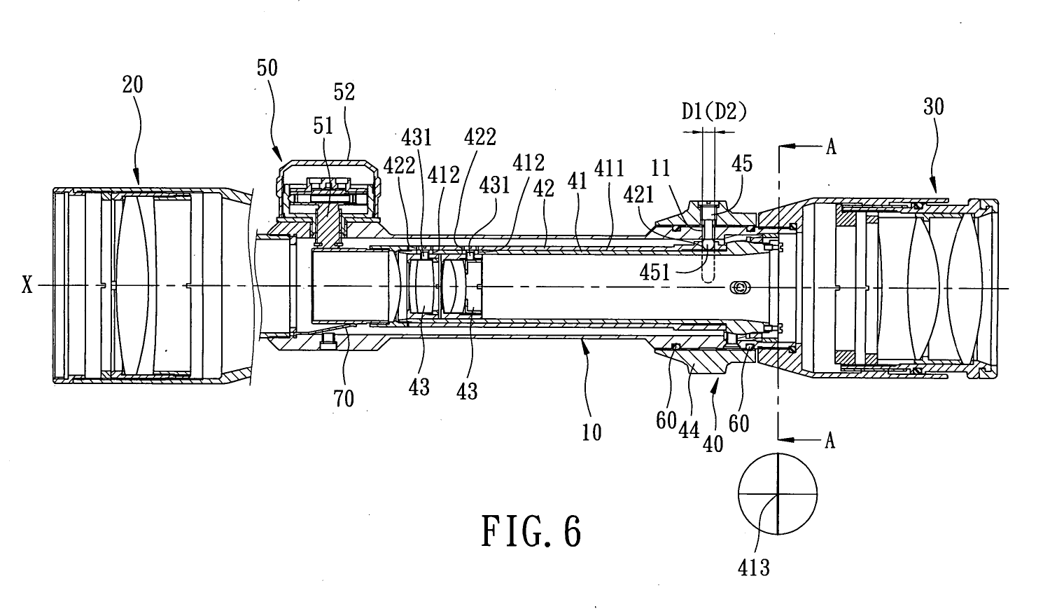

The outer barrel 10 is formed with a circumferentially extending slot 11. The outer barrel 10 has a longitudinal axis (X), which is indicated in FIG. 6, and first and second ends.

The objective lens unit 20 is mounted to the first end of the outer barrel 10.

The ocular lens unit 30 is mounted to the second end of the outer barrel 10.

The magnification unit 40 includes a first inner barrel 41 tiltably disposed in and extending between the first and second ends of the outer barrel 10, a second inner barrel 42 sleeved on the first inner barrel 41, a plurality of lens assemblies 43 movably disposed in the first inner barrel 41, an adjusting ring 44 sleeved on the outer barrel 10, and an adjusting pin 45 mounted to the adjusting ring 44.

The first inner barrel 41 has a rear end coupled pivotally to the outer barrel 10 in a known manner such that the first inner barrel 41 is tiltably disposed in the outer barrel 10.

The second inner barrel 42 is formed with a driven hole 421 having a first diameter (D1). The driven hole 421 is registered with the circumferentially extending slot 11, and is defined by a substantially cylindrical hole-defining wall.

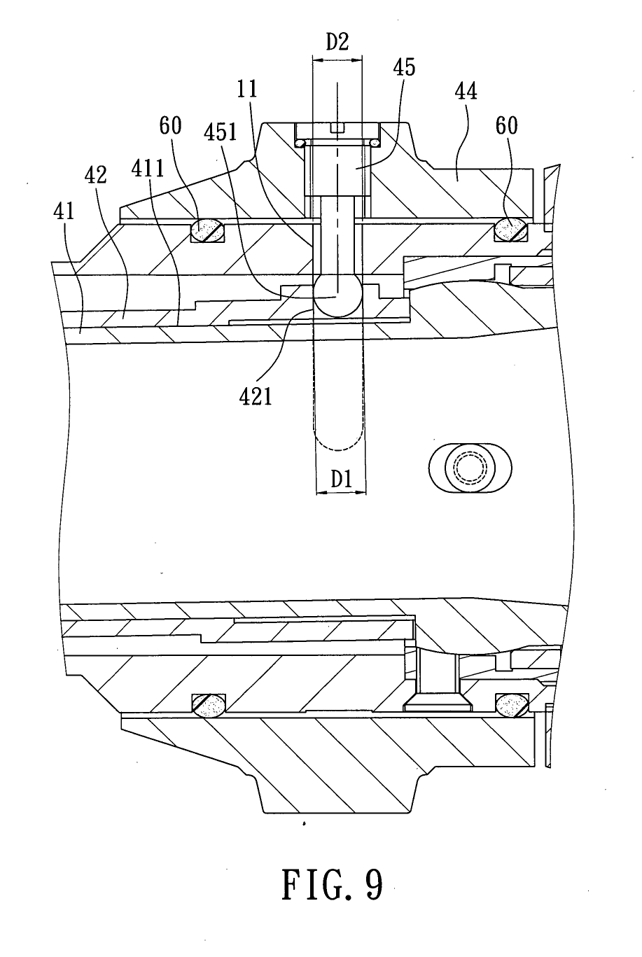

The adjusting pin 45 extends through and is movable along the slot 11, and includes a drive end 451 received in the driven hole 421. The drive end 451 of the adjusting pin 45 is substantially spherical, and has a second diameter (D2) that is not larger than the first diameter (D1) of the driven hole 421. Furthermore, the first inner barrel 41 has an outer barrel surface 411, and the drive end 451 of the adjusting pin 45 forms a clearance with the outer barrel surface 411 when received in the driven hole 421 of the second inner barrel 42, as best shown in FIG. 9.

The first inner barrel 41 is formed with a plurality of first cam slots 412 registered respectively with the lens assemblies 43. The first inner barrel 41 is further provided with a reticle 413 in a known manner. The second inner barrel 42 is formed with a plurality of second cam slots 422 registered respectively with the lens assemblies 43. Each of the lens assemblies 43 includes a guide pin 431 that passes through a corresponding one of the first cam slots 412 and that extends into a corresponding one of the second cam slots 422.

Each of the adjustment units 50 is mounted on the outer barrel 10, and includes an adjusting element 51 with a lower end abutting against the first inner barrel 41, and a cover 52 surrounding the adjusting element 51. Upon removal of the cover 52, the adjusting element 51 may be manipulated to thereby vary the position of the first and second inner barrels 41,42 in the outer barrel 10 relative to the longitudinal axis (X) of the outer barrel 10. Through provision of both of the adjustment units 50, the user is able to perform both elevation and windage adjustment of the reticle 413 provided on the first inner barrel 41.

The sealing rings 60 are spaced apart from each other, and are interposed between the outer barrel surface 411 of the outer barrel 10 and an inner ring surface of the adjusting ring 44. The adjusting pin 45 is disposed between the sealing rings 60.

The restoring spring 70 is interposed between the outer barrel 10 and the first inner barrel 41. In this embodiment, the restoring spring 70 is disposed on a side of the first inner barrel 41 such that an urging force is provided to the first inner barrel 41 to abut against the adjustment units 50.

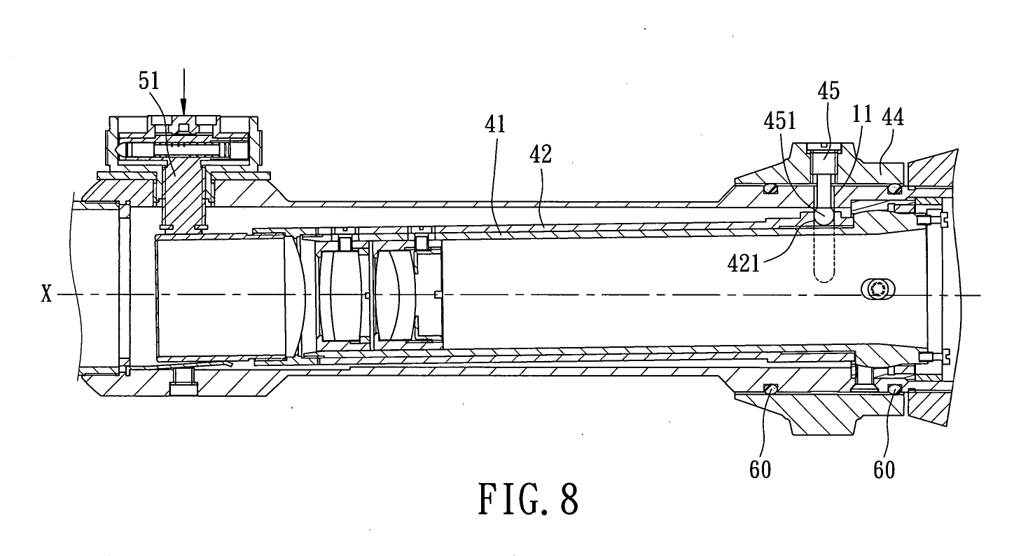

Operation of the adjustment unit 50 used for elevation control will now be described with reference to FIGS. 6 and 8. Manipulation of this adjustment unit 50 by the user results in upward or downward displacement of the adjusting element 51. Since the adjustment element 51 abuts against the first inner barrel 41 as described above, such upward or downward displacement of the adjusting element 51 results in upward or downward tilting of the first and second inner barrels 41,42. Hence, the reticle 413 may undergo elevation adjustment, thereby allowing for correction between an aiming position of the optical sight and an actual bullet impact point. Similarly, by adjusting the other one of the adjustment units 50 (see FIG. 5), windage adjustment of the reticle 413 may be performed.

If the user desires to vary the magnification of the optical sight, the adjusting ring 44 is rotated such that the adjusting pin 45 moves within the angular range of the slot 11. Through engagement between the adjusting pin 45 and the driven hole 421 in the second inner barrel 42, such rotation of the adjusting ring 44 results in rotation of the second inner barrel 42 relative to the first inner barrel 41. As a result, and through interaction between the guide pins 431 and the first and second cam slots 412, 422, the lens assemblies 43 are moved closer or farther apart from each other approximately along the direction of the longitudinal axis (X) of the outer barrel 10, thereby varying the magnification of the optical sight.

The optical sight of this invention has the following advantages:

1. Since the drive end 451 of the adjusting pin 45 is spherical, the second diameter (D2) of the drive end 451 is not larger than the first diameter (D1) of the driven hole 421, and the drive end 451 of the adjusting pin 45 forms a clearance with the outer barrel surface 411 of the first inner barrel 41, no mechanical interference occurs between the drive end 451 of the adjusting pin 45 and the driven hole 421 in the second inner barrel 42, even with extreme elevation adjustment as shown in FIG. 8. Hence, precise inclination adjustment of the first and second inner barrels 41,42 may take place by operation of the adjustment units 50, ultimately allowing for accurate adjustment of the reticle 413.

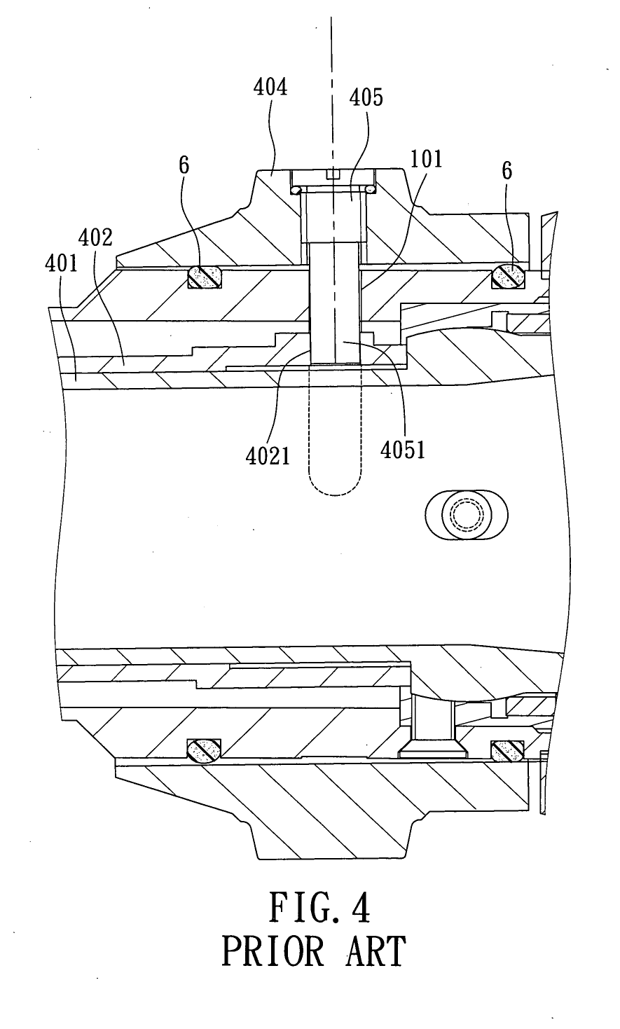

2. Since no mechanical interference occurs between the drive end 451 of the adjusting pin 45 and the driven hole 421 in the second inner barrel 42 during tilting adjustment of the first and second inner barrels 41,42 as described above, the driven hole 421 is unable to act on the adjusting pin 45 in such a manner that the adjusting pin 45 forces the adjusting ring 44 to tilt forward as in the prior art (see FIG. 4). Therefore, no mechanical interference occurs between the adjusting pin 45 and the slot 11, and there is no hindrance to the smooth rotation of the adjusting ring 44 during magnification adjustment. Furthermore, since the adjusting ring 44 does not undergo any tilting, no uneven pressing of the sealing rings 60 occurs, such as in the prior art optical sight (see FIG. 4). Therefore, the waterproof and airtight capabilities of the optical sight are preserved.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An optical sight, comprising:
an outer barrel having a longitudinal axis, formed with a circumferentially extending slot, and having first and second ends;
an objective lens unit mounted to said first end of said outer barrel;
an ocular lens unit mounted to said second end of said outer barrel;
a magnification unit including a first inner barrel tiltably disposed in and extending between said first and second ends of said outer barrel, a second inner barrel sleeved on said first inner barrel, a plurality of lens assemblies movably disposed in said first inner barrel, an adjusting ring sleeved on said outer barrel, and an adjusting pin mounted to said adjusting ring, said second inner barrel being formed with a driven hole having a first diameter and registered with said circumferentially extending slot, said adjusting pin extending through and being movable along said slot from said adjusting ring and including a drive end received in said driven hole, said drive end being substantially spherical, and having a second diameter that is not larger than said first diameter of said driven hole; and
an adjustment unit mounted on said outer barrel, and operable to adjust inclination of said first and second inner barrels in said outer barrel relative to said longitudinal axis of said outer barrel.

2. The optical sight of claim 1, wherein said driven hole is defined by a substantially cylindrical hole-defining wall.

3. The optical sight of claim 1, wherein said first inner barrel has an outer barrel surface, said drive end of said adjusting pin forming a clearance with said outer barrel surface.

4. The optical sight of claim 1, further comprising a pair of spaced-apart sealing rings interposed between said outer barrel and said adjusting ring, said adjusting pin being disposed between said sealing rings.

5. The optical sight of claim 1, wherein said first inner barrel is formed with a plurality of first cam slots registered respectively with said lens assemblies, and said second inner barrel is formed with a plurality of second cam slots registered respectively with said lens assemblies, each of said lens assemblies including a guide pin that passes through a corresponding one of said first cam slots and that extends into a corresponding one of said second cam slots.

6. The optical sight of claim 1, further comprising a restoring spring interposed between said outer barrel and said first inner barrel, said restoring spring being disposed on a side of said first inner barrel to provide an urging force to said first inner barrel to abut against said adjustment unit.
